(19) United States
(12) Patent Application Publication
(10) Pub. No.: US 2007/0187879 A1
(43) Pub. Date: Aug. 16, 2007

(54) ADJUSTABLE MULTIPLE JAW CLAMP

(76) Inventor: Zion Ben-Gigi, Kfar Veradim (IL)

Correspondence Address: David Klein;DEKEL PATENT LTD., Beit HaRof'im, 18 Menuha VeNahala Street, Room 27, REHOVOT, omitted

(21) Appl. No.: 11/673,584

(22) Filed: Feb. 11, 2007

Related U.S. Application Data
(60) Provisional application No. 60/771,946, filed on Feb. 10, 2006.

(51) Int. Cl. B25B 1/00

(52) U.S. Cl. 269/6

(57) ABSTRACT

A clamp including a first clamping jaw assembly, a second clamping jaw assembly facing toward the first clamping jaw assembly, the second clamping jaw assembly including a plurality of jaw clamps, at least one of the jaw clamps being a pivoting jaw clamp which is pivoted about a pivot axis that goes longitudinally from the second clamping jaw assembly to the first clamping jaw assembly, the pivoting jaw clamp being pivotable to a position adjacent another of the jaw clamps of the second clamping jaw assembly and the pivoting jaw clamp being pivotable to a different position angularly spaced away from the other jaw clamp of the second clamping jaw assembly, and a tightening mechanism for tightening the clamping jaw assemblies against a workpiece.

### FIELD OF INVENTION

The present invention relates generally to clamps for clamping workpieces and the like and particularly to a clamp with adjustable multiple jaws.

### BACKGROUND OF THE INVENTION

Clamps are used mainly in carpentry and handcraft applications. There are many kinds of clamps used to grip objects. One kind of clamp, often referred to as a spring clamp, is provided with a spring that forces the jaws of the clamp towards one another. In order to use a spring clamp, one squeezes the handles of the clamp together, wherein the squeezing action works against the force of the spring, thereby spreading the clamp jaws apart and permitting insertion of a workpiece or workpieces between the jaws. Upon release of the squeezing force, the spring forces the jaws against the workpiece or workpieces.

A variation of the spring clamp is known as an adjustable clamp. In an adjustable clamp, a spring is provided that forces the jaws of the clamp away from one another. When a user squeezes the handles of the adjustable clamp towards one another, the clamp jaws are gradually brought closer to one another until they finally abut each other. A ratchet mechanism is provided that works against the force of the spring and arrests the clamping jaws at discrete positions as they approach one another. The ratchet mechanism thus permits adjusting and maintaining the clamping jaws at any desired position as the handles of the adjustable clamp are squeezed together. In this manner, the jaws may be clamped against a workpiece or workpieces placed between the jaws.

Bar clamps generally comprise a pair of clamping jaws that slide along a bar. A workpiece may be clamped between the jaws by abutting the jaws against opposite sides of the workpiece, and then tightening the jaws against the workpiece, such as by repetitive squeezing of a hand-held trigger mechanism.

The bar clamp may also be used to spread objects apart. This may be accomplished in some bar clamps by turning around the clamping jaws 180°, which reverses the advancing movement of the jaws along the bar towards each other into a retreating movement away from each other. The objects may be spread apart by abutting the jaws against the appropriate surfaces of the objects, and then moving the jaws in the spreading direction, such as by repetitive squeezing of the hand-held trigger mechanism.

There are clamps that have the ability to clamp in a wider area. One example is a bar clamp with a Y shape that offers an extra clamping cushion on the fixed area of the clamp (commercially available from Penn State Industries, referred to as the PSI Y Clamp). The clamp thus has three clamping points and spreads the clamping force over a greater area. However, the clamp has the disadvantage of taking up a large volume during storage and shipment and is not applicable for work with small surfaces.

Another approach is that on certain clamps there are drilled holes in the heads, which enable shop-made attachments to be added to the clamp head (an example being Rocker-Sure Foot Pipe Clamps, www.rockler.com). Once these hand attachments are applied, they may enable one to clamp a wider surface. The hand made parts are not part of the clamp and offer no flexibility.

### SUMMARY OF INVENTION

The present invention seeks to provide an improved clamp with a clamping force that can be spread over a wider area, and thus enable the user to set up and work quicker, and with fewer clamps, thus saving time and money, and including features that overcome the limitations of other clamps, while offering many advantages.

This may be achieved through extra point clamping. The improved and novel clamp may have jaws that open and close and may provide the option of a wider or narrower clamping area. The extended jaw clamp may be fixed to the rest of the clamp or may be provided as an add-on to the clamp. One or both ends of the clamp may be provided with such extended jaws.

There is thus provided in accordance with an embodiment of the present invention a clamp including a first clamping jaw assembly, a second clamping jaw assembly facing toward the first clamping jaw assembly, the second clamping jaw assembly including a plurality of jaw clamps, at least one of the jaw clamps being a pivoting jaw clamp which is pivoted about a pivot axis that goes longitudinally from the second clamping jaw assembly to the first clamping jaw assembly, the pivoting jaw clamp being pivotable to a position adjacent another of the jaw clamps of the second clamping jaw assembly and the pivoting jaw clamp being pivotable to a different position angularly spaced away from the other jaw clamp of the second clamping jaw assembly, and a tightening mechanism for tightening the clamping jaw assemblies against a workpiece.

The pivoting jaw clamp may pivot freely about the pivot axis. Alternatively, the pivoting jaw clamp may be lockable at predetermined angular positions about the pivot axis. The angular spread between the pivoting jaw clamp and the other jaw clamp of the second clamping jaw assembly may be in the range of 0°-180°, more preferably 0°-150°.

Alternatively, all the jaw clamps of the second clamping jaw assembly may be pivoting jaw clamps. The first clamping jaw assembly may also include at least one pivoting jaw clamp.

### BRIEF DESCRIPTION OF THE DRAWINGS

The present invention will be understood and appreciated more fully from the following detailed description taken in conjunction with the drawings in which:

FIGS. 1A and 1B are simplified pictorial illustrations of a clamp constructed and operative in accordance with an embodiment of the present invention, in respective spread-out and closed orientations of the jaw clamps, the clamp being a bar clamp with the fixed jaw clamp being spreadable;

FIG. 2 is a simplified pictorial illustration of the clamp of FIGS. 1A and 1B shown as a spreader clamp;

FIGS. 3A and 3B are simplified pictorial illustrations of a clamp constructed and operative in accordance with another embodiment of the present invention, in respective spread-out and closed orientations of the jaw clamps, the clamp being a bar clamp with both the fixed and moving jaw clamps being spreadable, creating a double pivoted clamp;

FIG. 4 is a simplified pictorial illustration of a clamp constructed and operative in accordance with yet another embodiment of the present invention, the clamp being an adjustable clamp with pivoted arms; and

FIG. 5 is a simplified pictorial illustration of a clamp constructed and operative in accordance with still another embodiment of the present invention, the clamp being a deep throat sliding bar clamp with pivoted arms.

### DETAILED DESCRIPTION OF EMBODIMENTS

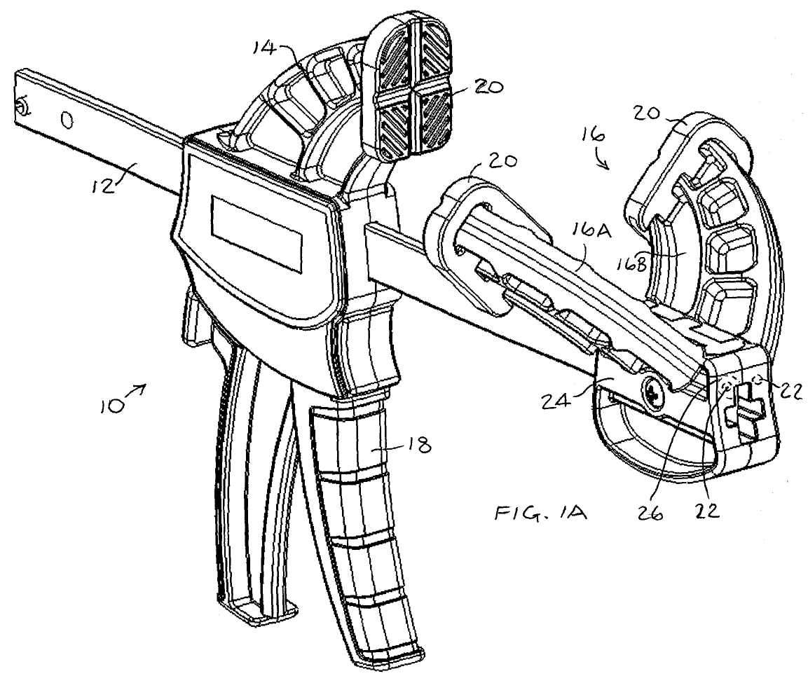

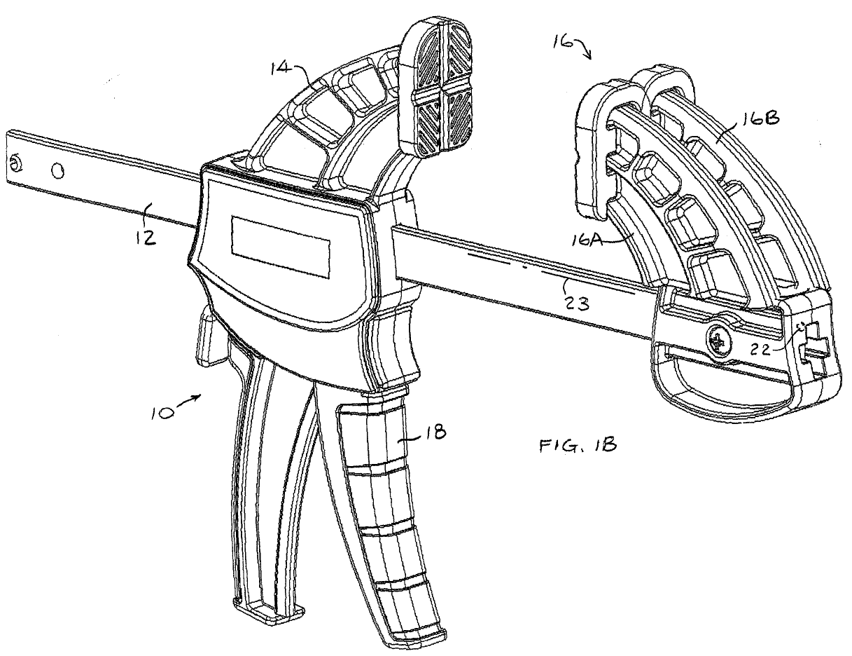

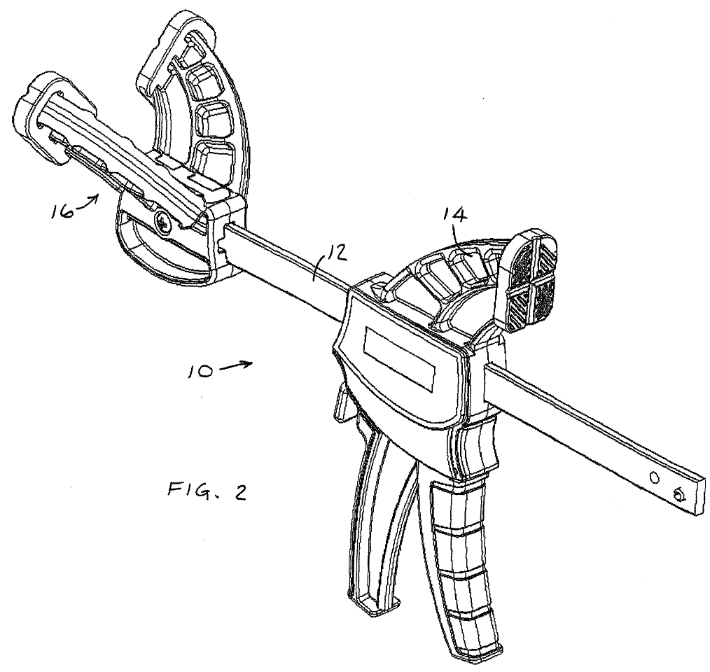

Reference is now made to FIGS. 1A, 1B and 2, which illustrate a clamp 10 constructed and operative in accordance with an embodiment of the present invention. Clamp 10 is a bar clamp that may include an elongate bar 12, a first clamping jaw assembly 14 movable along bar 12, a second clamping jaw assembly 16 fixedly attached to bar 12 and a tightening mechanism 18, such as a hand-held trigger mechanism, for tightening the clamping jaw assemblies against a workpiece (not shown). Tightening mechanism 18 may be constructed like many hand-held trigger mechanisms well known in the art. First clamping jaw assembly 14 may include a clamping jaw 20, as is also well known in the art.

Second clamping jaw assembly 16 may include one or more pivoting jaw clamps 16A and 16B. Jaw clamp 16A may pivot about a pivot axle 22 disposed inside a housing 24. Accordingly, pivoting jaw clamp 16A is pivoted about a pivot axis 23 that goes longitudinally from second clamping jaw assembly 16 to first clamping jaw assembly 14 (passing through pivot axle 22). Jaw clamp 16A may pivot freely about pivot axle 22 or may be locked at predetermined angular positions, such as by means of a pawl or ratchet mechanism 26. Jaw clamp 16A may be pivoted through any angular range about pivot axle 22 (the non-limiting illustrated angle makes them resemble the letter Y), so that the angular spread between jaw clamps 16A and 16B is 0°-180° or even more than 180°. Jaw clamp 16B may either be fixed at any suitable angle or may also pivot about a pivot axle 22. Jaw clamps 16A and 16B may also include clamping jaws 20.

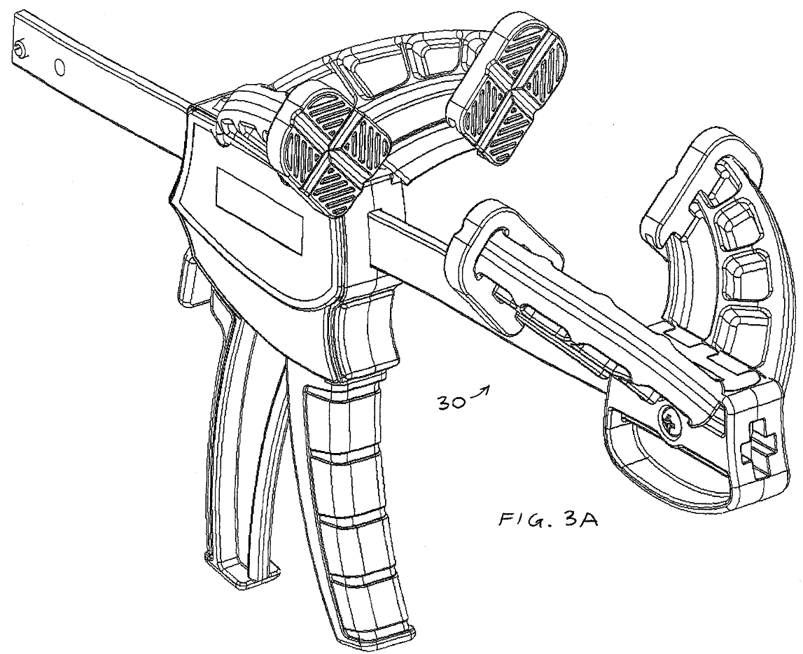

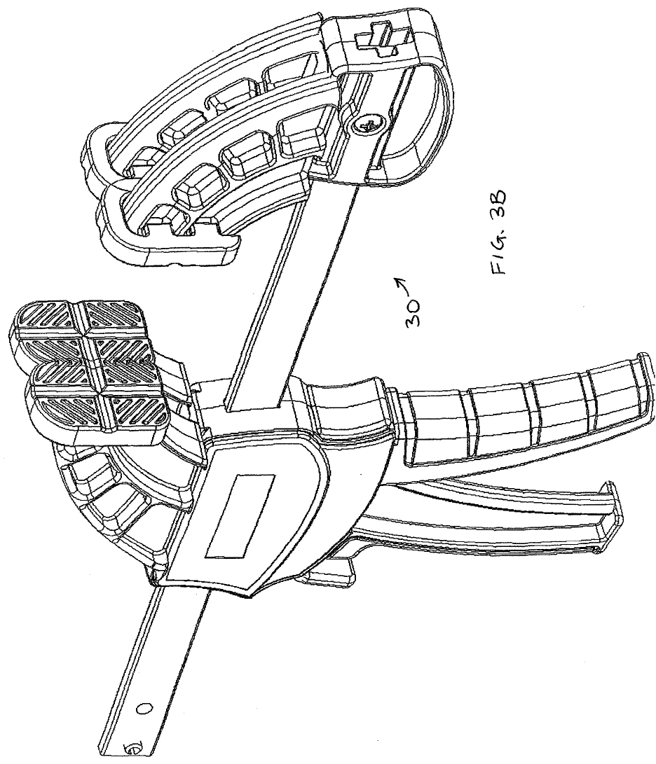

Reference is now made to FIGS. 3A and 3B, which illustrate a clamp 30 constructed and operative in accordance with another embodiment of the present invention, in respective spread-out and closed orientations of the jaw clamps. Clamp 30 is basically the same as clamp 10, except that clamp 30 is a bar clamp with both the fixed and moving jaw clamps being spreadable, creating a double pivoted clamp.

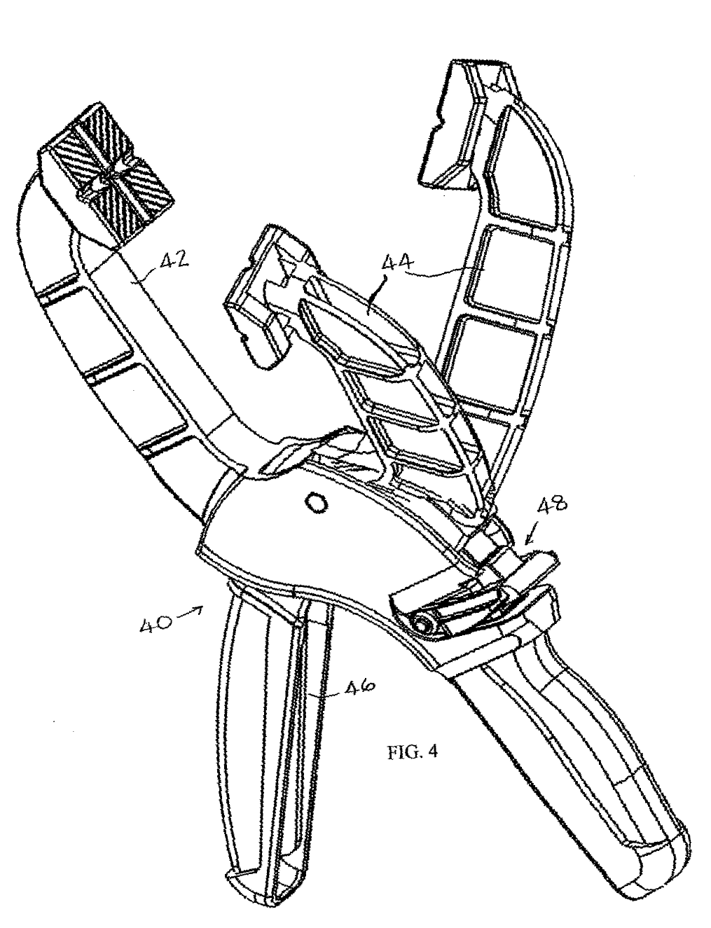

Reference is now made to FIG. 4, which illustrate a clamp 40, constructed and operative in accordance with yet another embodiment of the present invention. Clamp 40 is an adjustable clamp with one fixed jaw clamp arm 42 and a pair of pivoted jaw clamp arms 44, which may pivot as described above for the embodiment of FIGS. 1A-1B. As with conventional adjustable clamps, clamp 40 has a pair of handles 46 and a releasable ratchet mechanism 48.

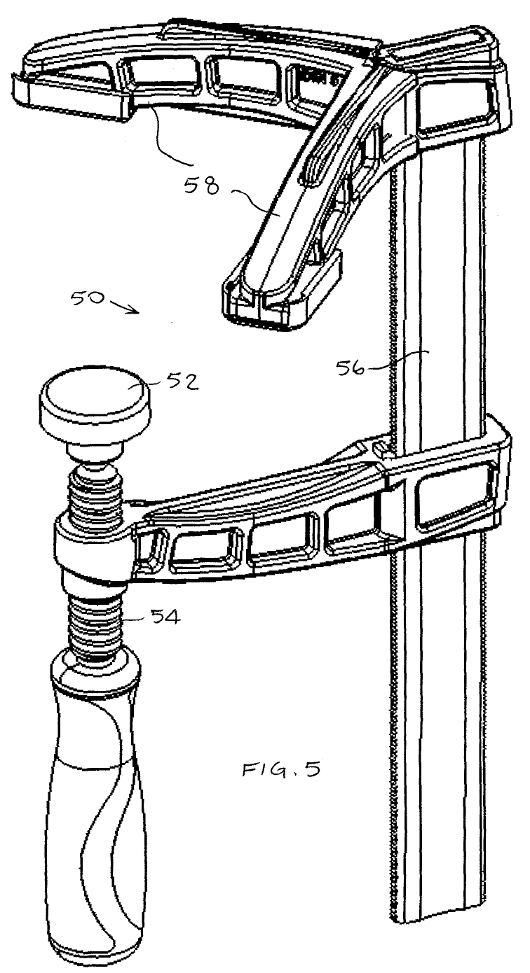

Reference is now made to FIG. 5, which illustrate a clamp 50, constructed and operative in accordance with still another embodiment of the present invention. Clamp 50 is a deep throat sliding bar clamp with one jaw 52 on a rotating tightening spindle 54 and a pair of pivoted jaw clamp arms 58, which may pivot as described above for the embodiment of FIGS. 1A-1B. Clamp arms 58 may be fixed to a bar 56.

The clamps of the invention may be sold in closed positions in order to save on storage space. The pivoting jaw may be sold as part of the clamp or may be sold as an accessory that can fit onto any portion of the clamp, be it fixed or moving.

The clamp of the invention may be made from a range of materials (e.g., plastic, metal), or a combination of materials and adapted to a range or family of clamps.

The scope of the present invention includes both combinations and sub-combinations of the features described herein above as well as modifications and variations thereof which would occur to a person of skill in the art upon reading the foregoing description and which are not the prior art.

What is claimed is:

1. A clamp comprising:
a first clamping jaw assembly;
a second clamping jaw assembly facing toward said first clamping jaw assembly, said second clamping jaw assembly comprising a plurality of jaw clamps, at least one of the jaw clamps being a pivoting jaw clamp which is pivoted about a pivot axis that goes longitudinally from the second clamping jaw assembly to the first clamping jaw assembly, said pivoting jaw clamp being pivotable to a position adjacent another of the jaw clamps of said second clamping jaw assembly and said pivoting jaw clamp being pivotable to a different position angularly spaced away from said other jaw clamp of said second clamping jaw assembly; and
a tightening mechanism for tightening said clamping jaw assemblies against a workpiece.

2. The clamp according to claim 1, wherein said pivoting jaw clamp pivots freely about said pivot axis.

3. The clamp according to claim 1, wherein said pivoting jaw clamp is lockable at predetermined angular positions about said pivot axis.

4. The clamp according to claim 1, wherein an angular spread between said pivoting jaw clamp and said other jaw clamp of said second clamping jaw assembly is 0°-180°.

5. The clamp according to claim 1, wherein all the jaw clamps of said second clamping jaw assembly are pivoting jaw clamps.

6. The clamp according to claim 1, wherein said first clamping jaw assembly also comprises at least one pivoting jaw clamp.

7. The clamp according to claim 1, wherein said clamp comprises a bar clamp wherein said first clamping jaw assembly moves along a bar and said second clamping jaw assembly is fixed to said bar.

8. The clamp according to claim 1, wherein said clamp comprises an adjustable clamp.

9. The clamp according to claim 1, wherein said clamp comprises a deep throat sliding bar clamp with said first clamping jaw assembly on a rotating tightening spindle.
